(19) United States
(12) Patent Application Publication
(10) Pub. No.: US 2010/0208165 A1
(43) Pub. Date: Aug. 19, 2010

(54) LIGHT CONTROL LAYER OF BACKLIGHT, BACKLIGHT, LIQUID CRYSTAL DISPLAY DEVICE, AND METHOD FOR PRODUCING LIGHT CONTROL LAYER OF BACKLIGHT

(75) Inventor: Kentaro Kamada, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/680,577

(22) PCT Filed: Jun. 11, 2008
(86) PCT No.: PCT/JP2008/060658

§ 371 Date: Mar. 29, 2010

(30) Foreign Application Priority Data
Oct. 9, 2007 (JP) 2007-263763

(51) Int. Cl. G02F 1/13357; G02B 5/02; G02B 27/28; G09F 13/04; G02C 7/00

(52) U.S. Cl. 349/64; 359/599; 359/487; 362/97.1; 156/99

(57) ABSTRACT

A light control layer (30) includes an adhesive layer (60); and at least two optical sheets (a reflective polarizer layer (40) and a diffuser layer (32)) stacked so as to sandwich the adhesive layer (60). The adhesive layer (60) includes a low reflectance section A having a reflectance lower than a reflectance of each of two optical sheets (a reflective polarizer layer (40) and a diffuser layer (32)) which are firmly fixed to each other by the adhesive layer (60).

### TECHNICAL FIELD

The present invention relates to a light control layer used in a display device, and in particular, to an optical sheet layer of a backlight.

### BACKGROUND ART

Conventionally, a backlight has been widely used as a light source section for a liquid crystal display device or the like. The following provides an explanation, with reference to drawings.

FIG. 4 is a cross sectional view schematically illustrating an arrangement of a conventional liquid crystal display device. As shown in FIG. 4, a backlight 20 is provided on a backside of a liquid crystal display panel 10 in a liquid crystal display device 1. The backlight 20 illuminates the liquid crystal display panel 10 from the backside of the liquid crystal display panel 10. The backlight 20 is chiefly made of a light control layer 30 and a light source section 50.

This light control layer 30 is used for collecting and/or uniformly diffusing light emitted from the light source section 50.

This light control layer 30 generally includes a diffuser plate 32, a diffuser sheet 34, and a reflective polarizer layer 40. On both sides of the reflective polarizer layer 40, there are generally respective protective films 42 and 44 laminated thereon.

The reflective polarizer layer 40 means a layer, such as DBEF (Product Name; manufactured by 3M Company), that has a function to transmit only one polarized light component, for example, only a p-wave component whereas to reflect a remaining s-wave component in a case where polarized light that reaches the reflective polarizer layer 40 is divided into the p-wave component and the s-wave component. Note that this reflective polarizer layer may be called a polarizing mirror layer.

The light control layer 30 is formed by stacking the above layers so that an air layer is sandwiched between every two adjacent layers.

(Patent Literature 1)

One example of the backlight having such an arrangement is a film stack 200 (light control layer 30) described in Patent Literature 1.

FIG. 5 is a diagram illustrating a cross section of the film stack 200 described in Patent Literature 1.

Patent Literature 1 discloses the film stack 200 as shown in FIG. 5. The film stack 200 is formed by stacking a diffusing material layer 216 (diffuser sheet 34), two crossing prism structuring optical films 218 and 220, a reflective polarizer 222, and a diffusing material layer 224.

The film stack 200 is provided with tabs 418 on respective peripheries of the layers. On the tabs 418, a bonding agent 230 is applied and the bonding agent 230 firmly fixes the layers to each other. As a result, the film stack 200 forms one unit.

### Citation List

[Patent Literature 1] International Publication No. WO2005/024473 A2 (Publication Date: Mar. 17, 2005)

### SUMMARY OF INVENTION

However, the arrangement described in Patent Literature 1 has a problem such that (hereinafter, referred to as an optical sheet) included in a light control layer may be damaged, for example. This problem is explained below.

### (Air Layer Interposing Arrangement)

In the arrangement described in Patent Literature 1, optical sheets or the like are fixed to each other by use of an bonding agent at peripheries (sections where the tabs are formed) of the optical sheets or the like. Meanwhile, at center sections (sections except the peripheries where the tabs are formed) of the optical sheets or the like, the optical sheets or the like are not bonded to each other. There is only an air layer intervening between two adjacent optical sheets or the like.

Accordingly, at the center sections or the like, a surface of an optical sheet may be damaged due to rubbing between two adjacent optical sheets or the like.

This problem is conspicuous in a case where the optical control layer includes an optical sheet or the like (e.g., a reflective polarizer layer) that may in particular be easily damaged.

(Protective Layer)

In order to solve the above problem, for preventing the damage to the optical sheet or the like, the optical sheet or the like is provided with a protective layer by staking, on a surface of the optical sheet or the like, a layer such as a film or the like for protection (hereinafter, referred to as a protective film or the like).

In other words, as previously explained with reference to FIG. 4, for example, both sides of the reflective polarizer layer 40 are provided with respective protective layers, by bonding the protective films 42 and 44 made of, for example, PC (Poly Carbonate). Such protective films 42 and 44 have a relatively high strength and hardness and are difficult to damage.

Further, particularly the reflective polarizer layer 40 may have a low stability in conformation of the reflective polarizer layer 40 itself. For compensating this low stability, the protective films are preferably provided.

In a case where the optical sheet or the like is laminated by use of the protective films or the like, a surface of each film becomes difficult to damage even in an arrangement (the air layer interposing arrangement described above) in which the optical sheets or the like are stacked so that only an air layer intervenes between the optical sheets or the like.

However, the arrangement using the protective films or the like as described above may cause the following problems: (i) an increase in cost due to an increase in the number of component parts or/and the number of process steps; and (ii) an increase in a thickness of the light control layer.

### (Adhesive Layer Interposing Arrangement (Unified Arrangement))

In order to solve the above problems, a possible arrangement may be an arrangement in which the adjacent optical sheets or the like is attached to each other via an adhesive layer formed on a substantially whole surface of each of the adjacent optical sheets. This arrangement is different from the arrangement in which only the air layer intervenes at the center sections of the optical sheets or the like and no other particular fixation means is provided at the center sections.

More specifically, for example, as shown in FIG. 6 that is a cross sectional view of the light control layer, a possible arrangement my be such that, in an arrangement whose light control layer 30 includes a reflective polarizer layer 40 and a diffuser plate 32, the reflective polarizer layer 40 and the diffuser layer 32 are attached to each other via an adhesive layer 60. In other words, this arrangement is an arrangement (unified arrangement) unifying the reflective polarizer layer 40 and the diffuser plate 32.

Though the light control layer 30 shown in FIG. 6 does not employ a diffuser sheet 34 included in a light control layer 30 shown in FIG. 4, it is not necessary in an arrangement using the adhesive layer 60 to always omit the diffuser sheet 34 or to have only one optical sheet or the like that has a diffusing function.

In this unified arrangement, the reflective polarizer layer 40 and the diffuser layer 32 which function as optical sheets do not come into direct contact with each other. Accordingly, surfaces of the optical sheet become difficult to damage. Further, even in a case where an optical sheet or the like included in the light control layer 30 is the reflective polarizer layer 40 or the like having a low stability in conformation, the reflective polarizer layer 40 or the like is in contact with the adhesive layer 60 and also unified with the diffuser plate 32 via the adhesive layer 60. Therefore, the low stability in conformation of the reflective polarizer layer 40 or the like can be compensated.

In addition, the protective films or the like becomes dispensable. Therefore, it becomes possible to reduce the number of component parts, the number of process steps, production cost, and/or a thickness.

However, in the adhesive interposing arrangement using an adhesive, a light transmittance of the light control layer 30 lowers. This causes a problem such that a luminance of the liquid crystal display device 1 lowers.

More specifically, as compared with the arrangement, as shown in FIG. 4, where the protective films 42 and 44 are provided on the respective surfaces of the reflective polarizer layer 40, a luminance of the liquid crystal display device 1 becomes lower by approximately 15% in this adhesive interposing arrangement though the protective films 42 and 44 (in particular, the protective film 42 on an entrance plane of the reflective polarizer layer 40) are omitted.

The present invention is attained in view of the above problems. An object of the present invention is to provide a light control layer of a backlight allowing for reduction of the number of component parts and also allowing for prevention of deterioration of a light transmittance, the backlight, a liquid crystal display device, and a method for producing the light control layer of the backlight.

In order to solve the problems described above, the light control layer of the present invention includes: a fixation layer; and at least two optical sheets stacked so as to sandwich the fixation layer, the fixation layer including a low reflectance section having a reflectance lower than a reflectance of each of two optical sheets which are firmly fixed to each other by the fixation layer.

(Number of Parts)

According to the above arrangement, the optical sheets (a layer, a film, a sheet, a coat, a plate, etc., included in the light control layer) are stacked so as to sandwich the fixation layer. Accordingly, unlike a case where the optical sheets are stacked so as to sandwich only an air layer, the optical sheets stacked are prevented from being damaged due to rubbing between the optical sheets. Therefore, it is possible to omit protective films used for laminating an optical sheet for the purpose of preventing damage on the optical sheet.

Further, at least two optical sheets are stacked/firmly fixed to each other via an adhesive layer and unified. Therefore, even in a case where the optical sheet by itself has a poor stability in conformation, such an optical sheet can be used by itself as a constituent member (optical sheet) of the light control layer while no additional protective film or the like is used.

As described above, according to the above arrangement, the protective films can be omitted. This makes it possible to reduce the number of parts and also to reduce a thickness of the light control layer.

### (Light Transmittance)

According to the arrangement described above, in the fixation layer, a low reflectance section is formed. This low reflectance section has a reflectance lower than a reflectance of each of the two optical sheets which are firmly fixed to each other by the fixation layer. Regarding the two optical sheets opposed to each other via the fixation layer, loss of light traveling from one of the optical sheets to a fixation layer and loss of light traveling from the fixation layer to the other optical sheet are reduced in the low reflectance section.

Accordingly, in the low reflectance section of the fixation layer, deterioration of a light transmittance is prevented. The light transmittance here means an indicator indicating a ratio of light that travels from one optical sheet out of the plurality of optical sheets stacked so as to sandwich the fixation layer and that reaches another optical sheet.

As described above, the above arrangement makes it possible to reduce the number of parts and also to provide a light control layer of a backlight that makes it possible to prevent deterioration of a light transmittance.

The fixation layer means a layer that fixes the two optical sheets that are stacked so as to sandwich the fixation layer and prevents displacement or the like of the two optical sheets.

More specifically, the fixation layer is formed as an adhesive layer made of an adhesive or as a bonding layer made of a bonding agent. Similarly, an adhesive agent means a material for forming the fixation layer, including the adhesive and/or the bonding agent.

Further, in the light control layer of the present invention, preferably, the low reflectance section is in contact with each of the two optical sheets which are firmly fixed to each other by the fixation layer.

According to the arrangement, a low reflectance section in the fixation layer is in contact with both of the two optical sheets which are firmly fixed to each other by the fixation layer.

Therefore, in the low reflectance section of the fixation layer, light emitted from one of the two optical sheets towards the other one of the two optical sheets can reach the other optical sheet, after the light only passes through the low reflectance section but not through other sections of the fixation layer.

This makes it possible to more effectively prevent deterioration of the light transmittance.

In the light control layer of the present invention, preferably, the low reflectance section is an air bubble.

According to the above arrangement, the low reflectance section is an air bubble, that is, the air. Therefore, a reflectance of the low reflectance section can be reduced to a value close to a reflectance in vacuum.

As a result, deterioration of the light transmittance can be more effectively prevented.

In the light control layer of the present invention, the low reflectance section can be made of a hollow bead. The hollow bead here means a bead in which a cavity filled with the air is formed.

According to the above arrangement, it is possible to easily form the low reflectance section only by providing the hollow bead in the fixation layer.

In the light control layer of the present invention, the fixation layer can be formed into a striped pattern; and the low reflectance section can be a section between adjacent lines of the fixation layer in the striped pattern.

According to the above arrangement, it is possible to easily form the low reflectance section by forming the fixation layer into a striped pattern.

Further, the low reflectance section can be easily formed so as to be in contact with both of the two optical sheets which are firmly fixed to each other by the fixation layer.

In the light control layer of the present invention, at least one of the two optical sheets can be formed of an organic material.

According to the above arrangement, an optical sheet is made of an organic material. In general, an organic material has a high reflectance.

Therefore, deterioration of a light transmittance can be further prevented by forming the low reflectance section in the fixation layer.

In the light control layer of the present invention, preferably, at least one of the two optical sheets is a reflective polarizer layer.

In general, the reflective polarizer layer by itself has a low strength. Further, the reflective polarizer layer by itself has a poor stability in conformation. Therefore, the reflective polarizer layer is generally laminated with protective films made of, for example, PC (Poly Carbonate).

According the above arrangement, the reflective polarizer layer is stacked on another optical sheet via the fixation layer.

Therefore, the protective film becomes dispensable. This makes it possible to reduce the number of parts of the light control layer.

Further, a backlight of the present invention preferably includes the light control layer described above.

According to the arrangement, the backlight is provided with a light control layer having a high light transmittance. This makes it possible to provide a backlight having a high efficiency in utilization of light.

Further, a liquid crystal display device of the present invention preferably includes the backlight.

According to the arrangement, the liquid crystal display device is provided with the backlight having a high efficiency in utilization of light. This makes it possible to provide a liquid crystal display device that is bright at a low power consumption.

In order to solve the problems described above, a method for producing a light control layer of a backlight of the present invention, the light control layer including: at least a first optical sheet and a second optical sheet; and a fixation layer, the first optical sheet and the second optical sheet being stacked so as to sandwich the fixation layer, the method includes the steps of: stirring an adhesive agent so as to introduce air bubbles into the adhesive agent; forming the fixation layer by applying, onto the first optical sheet, the adhesive agent containing the air bubbles; and stacking the first optical sheet and the second optical sheet so that the fixation layer formed is sandwiched between the first optical sheet and the second optical sheet.

The above method makes it possible to introduce air bubbles into the fixation layer, by adjusting a stirring condition or the like of the adhesive agent. This makes it possible to easily form the low reflectance section in the fixation layer.

In order to solve the problems described above, a method for producing a light control layer of a backlight of the present invention, the light control layer including: at least a first optical sheet and a second optical sheet; and a fixation layer, the first optical sheet and the second optical sheet being stacked so as to sandwich the fixation layer, the method includes the steps of: adding hollow beads to an adhesive agent and stirring the adhesive agent including the hollow beads; forming the fixation layer by applying, onto the first optical sheet, the adhesive agent in which the hollow beads are dispersed; and stacking the first optical sheet and the second optical sheet so that the fixation layer formed is sandwiched between the first optical sheet and the second optical sheet.

The above method makes it possible to easily form the low reflectance section in the fixation layer, by adding the hollow beads into the adhesive agent.

In order to solve the problems described above, a method for producing a light control layer of a backlight of the present invention, the light control layer including: at least a first optical sheet and a second optical sheet; and a fixation layer, the first optical sheet and the second optical sheet being stacked so as to sandwich the fixation layer, the method includes the steps of: applying the adhesive agent onto the first optical sheet so as to form the fixation layer; dispersing hollow beads on a surface of the fixation layer; and stacking the first optical sheet and the second optical sheet so that the fixation layer formed is sandwiched between the first optical sheet and the second optical sheet.

The above method makes it possible to easily form the low reflectance section in the fixation layer, by dispersing the hollow beads in the adhesive layer.

In order to solve the problems described above, a method for producing a light control layer of a backlight of the present invention, the light control layer including: at least a first optical sheet and a second optical sheet; and a fixation layer, the first optical sheet and the second optical sheet being stacked so as to sandwich the fixation layer, the method includes the steps of: applying an adhesive agent in a striped pattern onto the first optical sheet so as to form the fixation layer; and stacking the first optical sheet and the second optical sheet so that the fixation layer formed is sandwiched between the first optical sheet and the second optical sheet.

The above method makes it possible to easily form the low reflectance section in the fixation layer, by applying the adhesive agent in a striped pattern.

Further, in the adhesive layer, a linear section where no adhesive agent is provided. Accordingly, even in a case where, for example, a temperature of the light control layer rises due to a change in an ambient temperature or the like and the air expands or the like in the section where no adhesive agent is formed, the expanded air can easily flow outside the light control layer through the section, as an escape path, where no fixation layer is formed. This makes it difficult to cause a defect such as peeling of the optical sheet stacked.

In order to solve the problems described above, a method for producing a light control layer of a backlight of the present invention, the light control layer including: at least a first optical sheet and a second optical sheet; and a fixation layer, the first optical sheet and the second optical sheet being stacked so as to sandwich the fixation layer, the method includes the steps of: applying an adhesive agent onto the first optical sheet so as to form the fixation layer; removing a part of the fixation layer formed, so as to form the fixation layer into a striped pattern; and stacking the first optical sheet and the second optical sheet.

The above method makes it possible to easily form the low reflectance section in the fixation layer, by removing a part of the adhesive agent.

As described above, the light control layer of the present invention includes: a fixation layer; and at least two optical sheets stacked so as to sandwich the fixation layer, the fixation layer including a low reflectance section having a reflectance lower than a reflectance of each of two optical sheets which are firmly fixed to each other by the fixation layer.

Further, the method for producing the light control layer of the backlight of the present invention includes the steps of: stirring an adhesive agent so as to introduce air bubbles into the adhesive agent; forming the fixation layer by applying, onto the first optical sheet, the adhesive agent containing the air bubbles; and stacking the first optical sheet and the second optical sheet so that the fixation layer formed is sandwiched between the first optical sheet and the second optical sheet.

The method for producing the light control layer of the backlight of the present invention includes the steps of: adding hollow beads to an adhesive agent and stirring the adhesive agent including the hollow beads; forming the fixation layer by applying, onto the first optical sheet, the adhesive agent in which the hollow beads are dispersed; and stacking the first optical sheet and the second optical sheet so that the fixation layer formed is sandwiched between the first optical sheet and the second optical sheet.

The method for producing the light control layer of the backlight of the present invention includes the steps of: applying an adhesive agent in a striped pattern onto the first optical sheet so as to form the fixation layer; and stacking the first optical sheet and the second optical sheet so that the fixation layer formed is sandwiched between the first optical sheet and the second optical sheet.

Therefore, it becomes possible to reduce the number of parts and also to provide a light control layer of a backlight allowing for prevention of deterioration of a light transmittance and a method for producing the light control layer of the backlight.

### BRIEF DESCRIPTION OF DRAWINGS

FIG. 1 is a cross sectional view schematically illustrating an arrangement of a liquid crystal display device according to an embodiment of the present invention.

FIG. 2 is a cross sectional view schematically illustrating an arrangement of a liquid crystal display device according to another embodiment of the present invention.

FIG. 3 is a cross sectional view schematically illustrating an arrangement of a liquid crystal display device according to still another embodiment of the present invention.

FIG. 4 is a cross sectional view schematically illustrating an arrangement of a liquid crystal display device according to a conventional technique.

FIG. 5 is a diagram schematically illustrating an arrangement of a backlight described in Patent Literature 1 according to a conventional technique.

FIG. 6 is a cross sectional view of a light control layer in which optical films are so stacked as to sandwich an adhesive.

### REFERENCE SIGNS LIST

1 Liquid Crystal Display Device
20 Backlight
30 Light Control Layer
40 Reflective Polarizer Layer
60 Adhesive Layer (Fixation Layer)
72 Air Bubble
74 Bead (Hollow Bead)
76 Air Gap
A Low Reflectance Section
B Adhesive Section

### DESCRIPTION OF EMBODIMENTS

### Embodiment 1

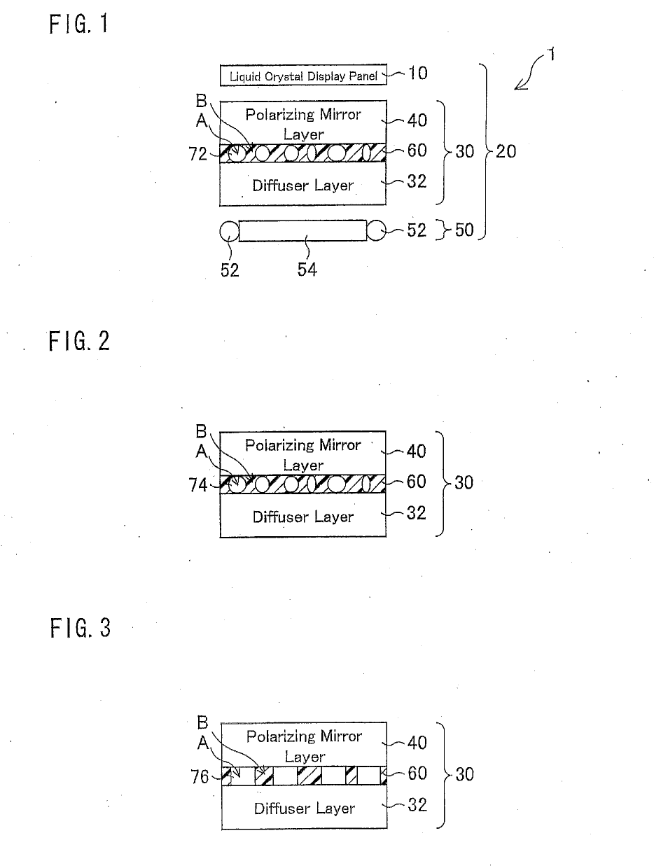

The following explains one embodiment of the present invention, with reference to FIG. 1.

FIG. 1 is a cross sectional view schematically illustrating an arrangement of a liquid crystal display device 1 according to the present embodiment. As shown in FIG. 1, in the similar manner to a conventional liquid crystal display device 1, the liquid crystal display device 1 of the present embodiment includes a liquid crystal panel 10, and a backlight provided on a backside of the liquid crystal panel 10.

This backlight 20 illuminates the liquid crystal display panel 10 from the backside of the liquid crystal panel 10. This backlight 20 chiefly includes a light control layer 30 and a light source section 50.

### (Light Source Section)

The light source section 50 includes a lamp 52 as a light source and a light guide plate 54 that guides light emitted from the lamp 52 to a display plane and that uniformly spreads the light.

### (Light Control Layer)

Then, the light emitted from the light source section 50 enters the light control layer 30. This light control layer 30 collects and/or uniformly diffuses the light emitted from the light source section 50. In the present embodiment, the light control layer 30 includes a diffuser plate 32 and a reflective polarizer layer 40 as optical sheets.

The diffuser plate 32 has a function to uniform luminance in a plane, by, for example, diffusing, inside or outside (on the surface of) the diffuser layer 32, the light having entered the light control layer 30.

As previously described, the reflective polarizer layer 40 has a function to transmit only polarized light in one direction whereas to reflect polarized light in the other directions. In the present embodiment, the reflective polarizer layer 40 is made of DBEF (Product Name) manufactured by 3M Company.

According to the arrangement described above, light is emitted from the light source section 50 and then enters the light control layer 30. The light having entered the light control layer 30 is first diffused by the diffuser plate 32 so that unevenness in luminance in a plane is reduced. Then, the reflective polarizer layer 40 uniforms polarization directions of the light to a certain extent.

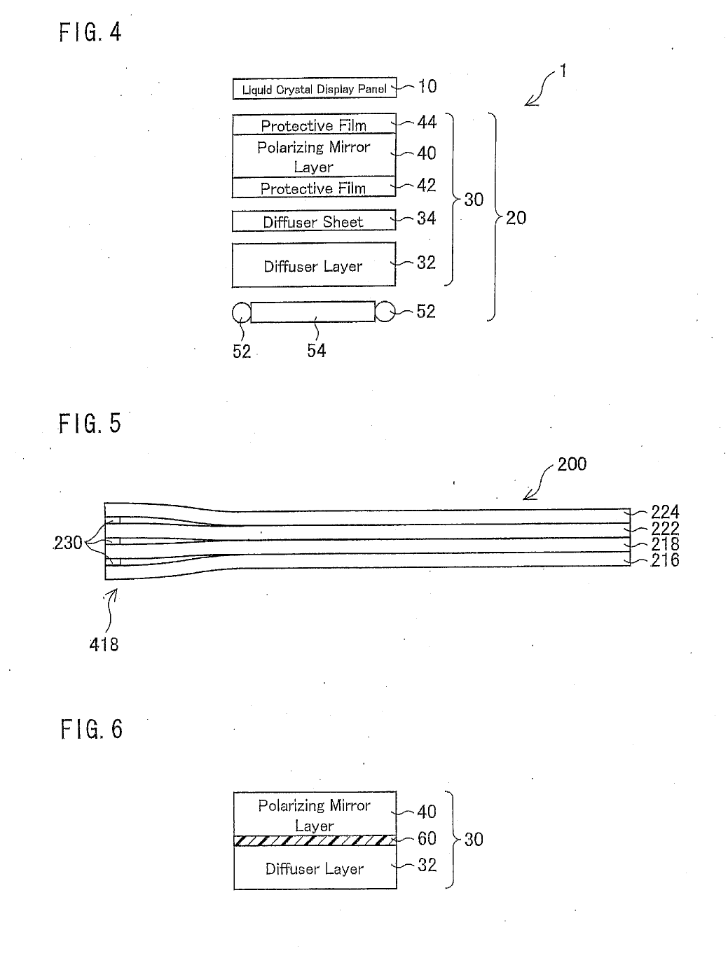

The optical sheets or the like constituting the light control layer 30 are not limited to the film described above. However, the optical sheets or the like may be changed as appropriate in accordance with desired optical characteristics or the like. For example, as previously explained with reference to FIG. 4, it is possible to add, for example, a diffuser sheet as a layer for diffusing light, in addition to the diffuser plate 32.

Further, it is also possible to provide only a function to diffuse light to the light control layer 30 and to omit the reflective polarizer layer 40.

### (Laminated Arrangement of Light Control Layer)

The following explains in more detail a layer arrangement of the light control layer 30.

The light control layer 30 of the present embodiment includes, for example, a layer, a film, a sheet, a coat, and a plate (hereinafter, referred to as optical sheets or the like) that are stacked so as to sandwich an adhesive.

In other words, as shown in FIG. 1, an adhesive layer 60 as a fixation layer is formed between the reflective polarizer layer 40 and the diffuser plate 32. A substantially whole surface of the reflective polarizer layer 40 is stacked on/firmly fixed to a substantially whole surface of the diffuser plate 32 via the adhesive layer 60.

The optical sheets or the like overlapped as described above are firmly fixed to each other. Therefore, a damage to an optical sheet due to rubbing between the optical sheets or the like overlapped can be prevented.

Further, a plurality of optical sheets or the like are firmly fixed to each other via an adhesive and unified. Therefore, even in a case where stability in confirmation of an optical sheet or the like itself is poor, that is, for example, even in a case where the optical sheet or the like is not sufficiently resistant to deformation, the optical sheet or the like can be independently used as a component part of the light control layer 30 while the optical sheet or the like is not laminated by use of any separate protective film or the like and not provided with any protective layer.

This makes it possible to reduce the number of component parts and also to reduce a thickness of the light control layer 30.

Note that a type of the adhesive forming the adhesive layer 60 is not specifically limited. Examples of usable types of the adhesive are an acrylic adhesive made of, for example, an acrylic ester copolymer, a vinyl adhesive made of, for example, vinyl ether polymer, and a rubber adhesive made of, for example, synthetic rubber.

### (Air Layer)

Further, the backlight 20 of the present embodiment is characterized in that a low reflectance section A (section A in FIG. 1) is provided in the adhesive layer 60. The low reflectance section A is a section that is in the adhesive layer 60 and that has a reflectance lower than respective reflectances of the optical sheets that are firmly fixed to each other by the adhesive layer 60. Further, the low reflectance section A has a reflectance lower than a reflectance of other section in the adhesive layer 60, for example, a section filled with only the adhesive (section B in FIG. 1).

### (Reflectance)

More specifically, in the present embodiment, the low reflectance section A is formed by an air bubble formed in the adhesive layer 60, as shown in FIG. 1. This air bubble is filled chiefly with the air.

The adhesive layer 60 in the present embodiment firmly fixes base materials (optical sheets or the like), that is, the reflective polarizer layer 40 and the diffuser plate 32 to each other. These base materials are generally made of an organic compound such as PET (Polyethylene Terephthalate) or PC (Poly Carbonate).

Accordingly, a reflectance of the low reflectance section A in the adhesive layer 60 becomes lower than respective reflectances of the optical sheets or the like that are firmly fixed to each other by the adhesive layer 60.

Further, as previously described, the adhesive layer 60 is made of an organic compound such as an acrylic adhesive. Accordingly, inside the adhesive layer 60, a section (low reflectance section A) occupied by an air bubble has a lower reflectance than a reflectance of a section (adhesive section B) chiefly occupied by the adhesive around the low reflectance section A.

The relation of the reflectances above can prevent deterioration of a transmittance of the light control layer. In addition, according to the relation, because sections having different reflectances are present within the adhesive layer 60, light is scattered inside the adhesive layer 60. This provides an effect of improving uniformity of in-plane brightness/luminance.

### (Size of Air Bubble)

The air bubble forming the low reflectance section A in the present embodiment is preferably in contact with respective boundary surfaces of the base materials (optical sheets or the like), that is, boundary surfaces of the reflective polarizer layer 40 and the diffuser plate 32, which are adhered by the adhesive layer 60.

This arrangement produces, in the low reflectance section A, a section where the base materials (the reflective polarizer layer 40 and the diffuser plate 32 in the present embodiment) are opposed to each other only via an air layer.

In the section where only the air layer intervenes between the base materials, light loss of transmission light is small. This makes it possible to further prevent deterioration of a light transmittance of the backlight.

### (Production Method)

The following provides an explanation of a method for producing the liquid crystal display device 1 of the present embodiment, focusing on a method for forming the adhesive layer 60. This method for forming the adhesive layer 60 is exactly a feature of the present embodiment.

Note that, regarding a method for producing other parts of the liquid crystal display device 1, a conventional method for producing the conventional liquid crystal display device 1 can be used.

The present embodiment does not specifically limit the method for forming the low reflectance section A in the adhesive layer 60, that is, a method for forming the air bubble in the adhesive layer 60. However, the following method can be used for forming the air bubble.

(Method for Introducing Air Bubbles into Adhesive Prior to Application)

When the adhesive is to be applied to a base material such as the diffuser plate 32, the adhesive to be applied is stirred in advance so that air bubbles are intentionally introduced into the adhesive. This stirring is carried out, for example, so as to aerate the adhesive. This gives an (forming) adhesive that is to be applied and that sufficiently contains the air.

Then, the adhesive is applied to the base material while the adhesive sufficiently contains the air within the adhesive. A material to which the adhesive is applied is not limited to a material that will actually become a component member of the light control layer 30, such as the diffuser plate 32. For example, the adhesive may be applied to other film to be coated (release film). Then, the adhesive formed as a coat may be used to bond, for example, the diffuser plate 32 and the reflective polarizer layer 40.

### (Method for Introducing Air at Application)

The method for forming air bubbles in the adhesive layer 60 includes another method in which, for example, the air is blown into an applied surface at the time when the adhesive is applied to a base material such as the diffuser plate 32.

### Embodiment 2

The following explains Embodiment 2 of the present invention, with reference to FIG. 2. FIG. 2 is a cross sectional view schematically illustrating an arrangement of a liquid crystal display device according to another embodiment of the present invention.

Note that arrangements other than explained below are the same as arrangements of Embodiment 1. For convenience of explanation, members given the same reference numerals as members explained in Embodiment 1 respectively have identical functions and explanations thereof are omitted.

Different from a liquid crystal display device 1 of Embodiment 1, a liquid crystal display device 1 of the present embodiment includes beads 74 dispersed in an adhesive layer 60.

Each of the beads 74 have the same function as an air bubble of Embodiment 1 and form a low reflectance section A in the adhesive layer 60.

In other words, the low reflectance section A is a section where a bead 74 is present in the adhesive layer 60.

The bead 74 may preferably be made of a material that allows a whole bead 74, that is, both an outer edge and an inner section of the bead 74, to have a lower reflectance than those of the optical sheets or the like and the adhesive which the bead 74 is in contact with. However, as long as a material allows at least the inner section to have a lower reflectance than those of the optical sheets and the adhesive, the material can be used for the bead 74 of the present embodiment.

In particular, the bead 74 having a hollow structure, that is, the bead 74 having an inside filled with the air is preferably used.

Further, a shape and a size of the bead 74 are not specifically limited. However, it is preferable that the bead 74 comes in contact with respective boundary surfaces of the optical sheets, that is, the reflective polarizer layer 40 and the diffuser plate 32, which are adhered to each other by the adhesive layer 60.

This arrangement produces, at the low reflectance section A, a section where the base materials (the reflective polarizer layer 40 and the diffuser plate 32) are opposed to each other not via the adhesive but only via the bead 74.

In such a section where only the bead 74 intervenes as described above, light loss of transmission light is small. This makes it possible to more effectively prevent deterioration of a light transmittance of the backlight.

### (Production Method)

The following provides an explanation of a method for producing the liquid crystal display device 1 of the present embodiment, focusing on a method for dispersing the beads 74 in the adhesive layer 60. This method for dispersing the beads 74 is exactly a feature of the present embodiment.

Note that, regarding a method for producing other parts of the liquid crystal display device 1, a conventional method for producing the liquid crystal display device 1 can be used.

In the present embodiment, the method for providing the low reflectance section A in the adhesive layer 60, that is, a method for dispersing the beads 74 in the adhesive layer 60 is not specifically limited. However, it is possible to disperse the beads 74 according to the following method, for example.

(Method for Dispersing Beads 74 in Adhesive Prior fo Application)

When the adhesive is to be applied to a base material such as the diffuser plate 32, the beads 74 desired to be dispersed in the adhesive layer 60 are added to the adhesive to be applied and the mixture of the adhesive and the beads 74 is stirred in advance. This gives an adhesive in which the beads 74 are dispersed.

Then, the adhesive in which the beads 74 are dispersed is applied to the base material.

In the same manner as explained in Embodiment 1, a material to which the adhesive is applied is not limited to a material that will actually become a component member of the light control layer 30, such as the diffuser plate 32. For example, the adhesive may be applied to other film to be coated (release film). Then, the adhesive formed as a coat may be used to bond, for example, the diffuser plate 32 and the reflective polarizer layer 40.

Note that the method for dispersing the beads 74 into the adhesive layer 60 is not limited to the method described above. However, it is possible to use the following method, for example.

### (Method for Dispersing Beads 74 at Application)

Other than dispersing in advance the beads 74 in the adhesive prior to application, it is possible to disperse the beads 74 in the adhesive layer 60 by dispersing the beads 74 on a surface of the adhesive having been applied to the base material.

Examples of such a method for dispersing the beads 74 on the surface of the adhesive are: a (dry) method according to which the beads 74 are dispersed by blowing the beads 74 by themselves with the use of the air or the like; and a (wet) method according to which the beads 74 are dispersed in a solution and then the solution containing the beads 74 is sprayed.

The method for dispersing the beads 74 at the application of the adhesive is not limited to a method according to which the beads 74 are dispersed allover the surface of the adhesive that has already been applied as described above. For example, an alternative method may be arranged such that the beads 74 are dispersed as needed in accordance with progress of the application while the adhesive is being applied to the base material.

### Embodiment 3

The following explains Embodiment 3 of the present invention, with reference to FIG. 3. FIG. 3 is a cross sectional view schematically illustrating an arrangement of a liquid crystal display device 1, according to still another embodiment of the present invention.

Note that arrangements other than explained below are the same as arrangements of Embodiments 1 and 2. For convenience of explanation, members given the same reference numerals as members explained in Embodiments 1 and 2 respectively have identical functions and explanations thereof are omitted.

Different from a liquid crystal display device 1 of each of Embodiments 1 and 2 described above, the liquid crystal display device 1 has an adhesive formed into a striped pattern in an adhesive layer 60.

In the adhesive layer 60, a section where the adhesive is not formed, in other words, a section where no adhesive is formed in a gap within the striped pattern of the adhesive has the same function as an air bubble of Embodiment 1. Such a section forms a low reflectance section A in the adhesive layer 60.

In other words, in the adhesive layer 60, the section where no adhesive is formed becomes the low reflectance section A.

(Production Method)

The following provides an explanation of a method for producing the liquid crystal display device 1 of the present embodiment, focusing on a method for forming the adhesive in a striped pattern in the adhesive layer 60. This method for forming the adhesive is exactly a feature of the present embodiment.

Note that, regarding a method for producing other parts of the liquid crystal display device 1, a conventional method for producing the liquid crystal display device 1 can be used. In the present embodiment, one example of a method for forming the adhesive in a striped pattern in the adhesive layer 60 is a method according to which, at application of the adhesive to a base material, the adhesive is applied in a plurality of parallel lines by use of an adhesive dispenser in which a plurality of nozzles are aligned.

This method makes it possible to form the adhesive in a striped pattern while causing no particular increase in the number of process steps.

As a method for forming the stripe pattern in the adhesive layer 60 is not limited to the method described above. However, the following method may be used, for example.

That is, it is possible to use a method in which: first the adhesive is applied uniformly on a surface of the base material and then the adhesive uniformly applied on the surface is formed into a striped pattern by thrusting, onto the adhesive applied, a mold which has an uneven surface forming a striped pattern.

An alternative method for forming the striped pattern is a method according to which: a striped mold is provided in advance on the surface of the base material to which the adhesive is to be applied; then, the adhesive is applied from above the striped mold; and the striped mold is removed after the adhesive is formed into a striped pattern.

The present invention is not limited to the embodiments described above, but may be altered by a skilled person within the scope of the claims. An embodiment based on a proper combination of technical means disclosed in different embodiments is encompassed in the technical scope of the present invention.

One example of an arrangement other than the embodiments described above is an arrangement in which, for example, a scale-like shaped or the like reflecting material is added and dispersed in the adhesive.

According to this arrangement, because the reflective material is added in the adhesive, it is possible to prevent absorption of light into the adhesive and to guide light reflected by the reflective material (adhesive portion B) toward the low reflectance section A. This makes it possible to prevent deterioration of a light transmittance.

Further, in the explanation described above, an explanation is provided regarding an arrangement using the adhesive for fixing between base materials. However, the present invention is not limited to the arrangement. The adhesive may be replaced by a bonding agent, for example.

Further, a type of the bonding agent used in such a case is not specifically limited. Examples of the bonding agent that may be used are: a synthetic resin bonding agent, an elastomeric bonding agent, and a solvent-evaporation type, chemical reaction type, hot-melt type, or pressure-sensitive type bonding agent.

### INDUSTRIAL APPLICABILITY

The light control layer of the present invention makes it possible to reduce the number of component parts. Further, the light control layer has a high light transmittance. Therefore, the light control layer of the present invention can be suitably used for a backlight used in a television liquid crystal display device which is required to have a high quality at a low cost.

1. A light control layer of a backlight, the light control layer comprising:
a fixation layer; and
at least two optical sheets stacked so as to sandwich the fixation layer,
the fixation layer including a low reflectance section having a reflectance lower than a reflectance of each of two optical sheets which are firmly fixed to each other by the fixation layer.

2. The light control layer as set forth in claim 1, wherein:
the low reflectance section is in contact with each of the two optical sheets which are firmly fixed to each other by the fixation layer.

3. The light control layer as set forth in claim 1, wherein:
the low reflectance section is an air bubble.

4. The light control layer as set forth in claim 1, wherein:
the low reflectance section is made of a hollow bead.

5. The light control layer as set forth in claim 1 wherein:
the fixation layer is formed into a striped pattern; and
the low reflectance section is a section between adjacent lines of the fixation layer in the striped pattern.

6. The light control layer as set forth in claim 1, wherein:
at least one of the two optical sheets are formed of an organic material.

7. The light control layer as set forth in claim 1, wherein:
at least one of the two optical sheets is a reflective polarizer layer.

8. A backlight comprising the light control layer as set forth in claim 1.

9. A liquid crystal layer comprising the backlight as set forth in claim 8.

10. A method for producing a light control layer of a backlight, the light control layer including:
at least a first optical sheet and a second optical sheet; and
a fixation layer,
the first optical sheet and the second optical sheet being stacked so as to sandwich the fixation layer,
the method comprising the steps of:
stirring an adhesive agent so as to introduce air bubbles into the adhesive agent;
forming the fixation layer by applying, onto the first optical sheet, the adhesive agent containing the air bubbles; and
stacking the first optical sheet and the second optical sheet so that the fixation layer formed is sandwiched between the first optical sheet and the second optical sheet.

11. A method for producing a light control layer of a backlight, the light control layer including:
at least a first optical sheet and a second optical sheet; and
a fixation layer,
the first optical sheet and the second optical sheet being stacked so as to sandwich the fixation layer,
the method comprising the steps of:
adding hollow beads to an adhesive agent and stirring the adhesive agent including the hollow beads;
forming the fixation layer by applying, onto the first optical sheet, the adhesive agent in which the hollow beads are dispersed; and
stacking the first optical sheet and the second optical sheet so that the fixation layer formed is sandwiched between the first optical sheet and the second optical sheet.

12. A method for producing a light control layer of a backlight, the light control layer including:
at least a first optical sheet and a second optical sheet; and
a fixation layer,
the first optical sheet and the second optical sheet being stacked so as to sandwich the fixation layer,
the method comprising the steps of:
applying an adhesive agent onto the first optical sheet so as to form the fixation layer;
dispersing hollow beads on a surface of the fixation layer; and
stacking the first optical sheet and the second optical sheet so that the fixation layer formed is sandwiched between the first optical sheet and the second optical sheet.

13. A method for producing a light control layer of a backlight, the light control layer including:
at least a first optical sheet and a second optical sheet; and
a fixation layer,
the first optical sheet and the second optical sheet being stacked so as to sandwich the fixation layer,
the method comprising the steps of:
applying an adhesive agent in a striped pattern onto the first optical sheet so as to form the fixation layer; and
stacking the first optical sheet and the second optical sheet so that the fixation layer formed is sandwiched between the first optical sheet and the second optical sheet.

14. A method for producing a light control layer of a backlight, the light control layer including:
at least a first optical sheet and a second optical sheet; and
a fixation layer,
the first optical sheet and the second optical sheet being stacked so as to sandwich the fixation layer,
the method comprising the steps of:
applying an adhesive agent onto the first optical sheet so as to form the fixation layer;
removing a part of the fixation layer formed, so as to form the fixation layer into a striped pattern; and
stacking the first optical sheet and the second optical sheet.
